(19) United States
(12) Patent Application Publication
(10) Pub. No.: US 2004/0100220 A1
(43) Pub. Date: May 27, 2004

(54) Weighted higher-order proportional-integral current regulator for synchronous machines

(76) Inventor: Zhenxing Fu, Ann Arbor, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/303,928

(22) Filed: Nov. 25, 2002

(51) Int. Cl. H02P 1/46

(52) U.S. Cl. 318/700

(57) ABSTRACT

A permanent magnet synchronous machine is controlled according to a d-axis current command I_{dse}* and a q-axis current command I_{qse}* needed to achieve a desired response of the machine. An actual d-axis current I_{dse} and an actual q-axis current I_{qse} are sensed and an angular velocity ωᵣ of the machine is sensed. A d-axis voltage command V_{dse}* is determined using a first proportional-integral regulator responsive to a d-axis current error ΔI_{d}, a q-axis current error ΔI_{q}, and the angular velocity ωᵣ. The first proportional-integral regulator includes a first weighted higher order term comprising a product of a first weighting factor, the angular velocity ωᵣ, and the q-axis current error ΔI_{q}. A q-axis voltage command V_{qse}* is determined using a second proportional-integral regulator responsive to the d-axis current error ΔI_{d}, the q-axis current error ΔI_{q}, and the angular velocity ωᵣ, wherein the second proportional-integral regulator includes a second weighted higher order term comprising a product of a second weighting factor, the angular velocity ωᵣ, and the d-axis current error ΔI_{d}.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to controlling synchronous dynamoelectric machines, and, more specifically, to a current regulator for synchronous machines wherein motor operation is well controlled over a wide range of speeds.

AC electric machines, such as induction, synchronous, reluctance machines, are very useful in high performance electric drive applications. For applications where system efficiency, system size, torque density, and dynamic response time are of concern, permanent magnet (PM) synchronous machines are often preferred. PM synchronous machines are especially well suited for use as motors with low power ratings or with large mechanical air gaps. They typically require a power supply with sinusoidal voltage waveforms for excitation. The voltage commands for controlling such machines are typically generated using vector control techniques, also known as field oriented control (FOC), to achieve fast dynamic response, high efficiency, optimal peak transient power or torque capability, and a wide range of operating speeds.

Worldwide demand for fuel-efficient, low-emission vehicles have motivated the automotive industry to develop alternative powertrain architectures, such as 1) integrated starter alternator (ISA) systems for stop/start vehicles, 2) hybrid combinations of an electric traction motor and a downsized internal combustion (IC) engine for hybrid electric vehicles (HEV), and 3) purely electric vehicles (EV). Because PM synchronous machines have the advantages of high efficiency, small size and volume, high torque and power densities, and fast dynamic response, they have become increasingly popular in these automotive applications as ISA motors for stop/start vehicles, and traction motors for HEV's and EV's. In addition, they are also popularly used in electric power assisted steering (EPAS) applications as steering wheel torque assist actuators.

Because of packaging and weight constraints in the automotive underhood environment, the PM synchronous machines used in HEV, ISA, or EV applications typically use high-energy rare-earth magnet materials and are designed into pancake shapes with high numbers of magnetic poles. Considering the maximum engine operating speed of 6000 RPM, the maximum electrical speed of the electric machine reaches 36,000 to 108,000 RPM for 12 to 36 magnetic pole configurations. Such a high operating electrical speed in conjunction with small size and weight constraints requires the machine drive system to have a maximum speed to base speed ratio of 5 or 6, or even higher. Consequently, it is necessary to utilize the field weakening regime of motor control. To achieve such a wide range of operating speeds and other performance requirements (e.g., fast dynamic response, high efficiency, high torque and speed control precision, and optimal peak transient power/torque capability), vector or field oriented control techniques become a necessity. Field oriented control is also necessary to meet drive system requirements of being able to operate at every torque load point as defined by the maximum torque-speed envelope to provide torque boost, driveline disturbance damping, regenerative braking, synchronization for gear shifts via speed controls, and starting of the IC Engine.

As is known in the art, the electrical dynamics of AC machines becomes poorer as machine speed increases. For PM synchronous machines, the deterioration of electrical dynamics is evidenced by the damping coefficient, σ, given in Eq. (1):

$$σ = \frac{{R}_{s} ( {L}_{d} - {L}_{q} )}{2 ( {L}_{d} - {L}_{q} )} \frac{1}{\sqrt{{ω}_{r}^{2} + {R}_{s}^{2} / {L}_{d} {L}_{q}}} \qquad ( 1 )$$

where, Rₛ is the winding resistance, L_{d}, L_{q} are the inductances along the d-axis and the q-axis, and or is the electrical speed in Radians per second.

Because of the high maximum electrical speeds of the electric machines used for ISA, HEV, or EV applications (which are even higher due to the tendency to have high magnetic pole counts, e.g., 12 to 36), the electrical dynamics become close to a critically unstable condition when operating speed approaches the maximum value. For example, at 4000 mechanical RPM for a practical HEV traction motor, σ=0.02, which indicates that the machine is severely under-damped. Such an under-damped system would cause oscillations in torque dynamic responses due to oscillations in current responses in both the d-axis and q-axis components. Consequently, the machine drive system cannot deliver the drive performance as commanded, and certain vehicular system functions cannot be realized.

One prior art solution has been to avoid high motor speeds (i.e., reducing the maximum operating speed of the machine) by connecting a transmission at the mechanical output of the drive. However, these systems lead to complex and bulky transmission gearboxes and/or increased cost, especially when a variable transmission gearbox is used.

It is also known to modify the gains of proportional-integral regulators within a motor controller at various operating points of a machine. A gain scheduling lookup table is calibrated using extensive tests which may be expensive and time consuming. Furthermore, only approximate results can be achieved because of the large number of variables and the ranges of values to be accounted for (e.g., temperatures and torque loads).

### SUMMARY OF THE INVENTION

The present invention has the advantages of maintaining stability of synchronous machines at high speeds at all torque loads in an adaptive manner without the use of lookup tables or extensive testing to characterize a drive system.

In one aspect of the invention, a method is provided for controlling a permanent magnet synchronous machine. A d-axis current command I_{dse}* and a q-axis current command I_{qse}* needed to achieve a desired response of the machine are determined. An actual d-axis current I_{dse} and an actual q-axis current I_{qse} are sensed. An angular velocity ωᵣ of the machine is sensed. A d-axis voltage command V_{dse}* is determined using a first proportional-integral regulator responsive to a d-axis current error ΔI_{d}, a q-axis current error ΔI_{q}, and the angular velocity ωᵣ. The d-axis current error comprises a difference between the d-axis current command I_{dse}* and the actual d-axis current I_{dse}, and the q-axis current error comprises a difference between the q-axis current command I_{qse}* and the actual q-axis current I_{qse}. The first proportional-integral regulator includes a first weighted higher order term comprising a product of a first weighting factor, the angular velocity ωᵣ, and the q-axis current error ΔI_{q}. A q-axis voltage command V_{qse}* is determined using a second proportional-integral regulator responsive to the d-axis current error ΔI_{d}, the q-axis current error ΔI_{q}, and the angular velocity ωᵣ, wherein the second proportional-integral regulator includes a second weighted higher order term comprising a product of a second weighting factor, the angular velocity ωᵣ, and the d-axis current error ΔI_{d}.

### BRIEF DESCRIPTION OF THE DRAWINGS

FIG. 1 is a block diagram of a PM synchronous drive system of the present invention.

FIG. 2 is a schematic, block diagram of a vector-controlled, field oriented motor controller in a preferred embodiment of the present invention.

FIG. 3 is a schematic, block diagram of a current regulator in a preferred embodiment of the present invention.

FIG. 4 is a schematic, block diagram of a proportional-integral regulator for direct-axis current according to one preferred embodiment of the present invention.

FIG. 5 is a schematic, block diagram of a proportional-integral regulator for quadrature-axis current according to one preferred embodiment of the present invention.

FIG. 6 is a plot of actual phase currents achieved during high speed operation of the present invention.

### DETAILED DESCRIPTION OF PREFERRED EMBODIMENTS

To solve the instability problems at high speeds, the damping conditions of the machine drive system when speed increases must be improved. As can be appreciated from Eq. (1), the damping condition of the machine depends on operating speed. The proportional-integral (PI) current regulator of the present invention improves the damping condition of the drive system adaptively and suppresses excessive electrical dynamics as speed increases by incorporating a weighted higher-order term which is comprised of the product of a weighting factor, the angular velocity of the machine, and a current error (e.g., the difference between commanded and actual current in the other axis of the vector control system).

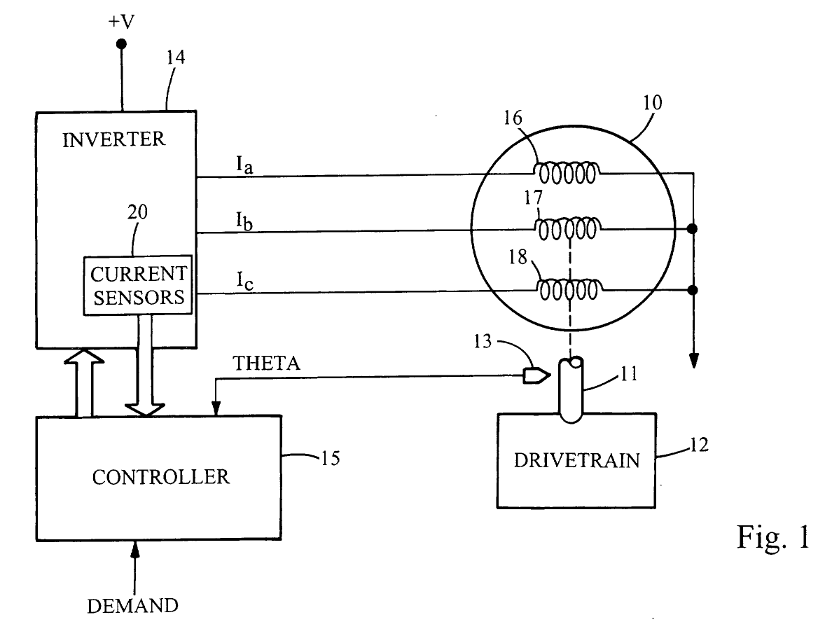

As shown in FIG. 1, a synchronous drive system may typically include a PM synchronous motor 10 with an output shaft 11 connected to a vehicle drivetrain 12, a position sensor 13 (or alternatively a position estimation mechanism in the controller in order to provide a sensorless embodiment), a power electronics inverter 14, and a controller apparatus 15. Motor 10 is shown as a 3-phase motor with phase windings 16-18, each connected between inverter 14 and ground. Inverter 14 may, for example, comprise current sensors 20, as well as a plurality of power electronics switches, a DC bus filter capacitor, a gate drive circuitry to control the power electronics switches, a cold plate to cool the power electronics switches, and a housing (not shown). Inverter 14 supplies phase currents Iₐ, I_{b}, and I_{c} to phase windings 16, 17, and 18, respectively.

Controller 15 may be of a mostly conventional type with improvements as described herein. In construction, it may comprise a number of analog electronic components on a printed circuit board, a microprocessor or digital signal processor chip, and other digital electronic components. Controller 15 receives a position signal Theta from position sensor 13, measured current signals I_{dse} and I_{qse} in the vector reference frame from current sensors 20, and a demand signal which may for example be a speed command as requested from a vehicle operator (e.g., via an accelerator pedal) or a supervisory powertrain controller.

Specific conventions are followed in the nomenclature of the variables throughout this specification. For example, a variable followed by “*” denotes a command value (i.e., a value for the variable representing an input by the vehicle supervisory controller or another internal process). Variables in the rotating vector reference frame include a subscript “d” which denotes a vector component in the direct axis (i.e., the direction of the current flow which is typically is responsible for production of the magnetic field or magnetic flux) or a subscript “q” which denotes a vector value in the quadrature (i.e., perpendicular) axis. The q-axis vector component is typically responsible for the production of torque.

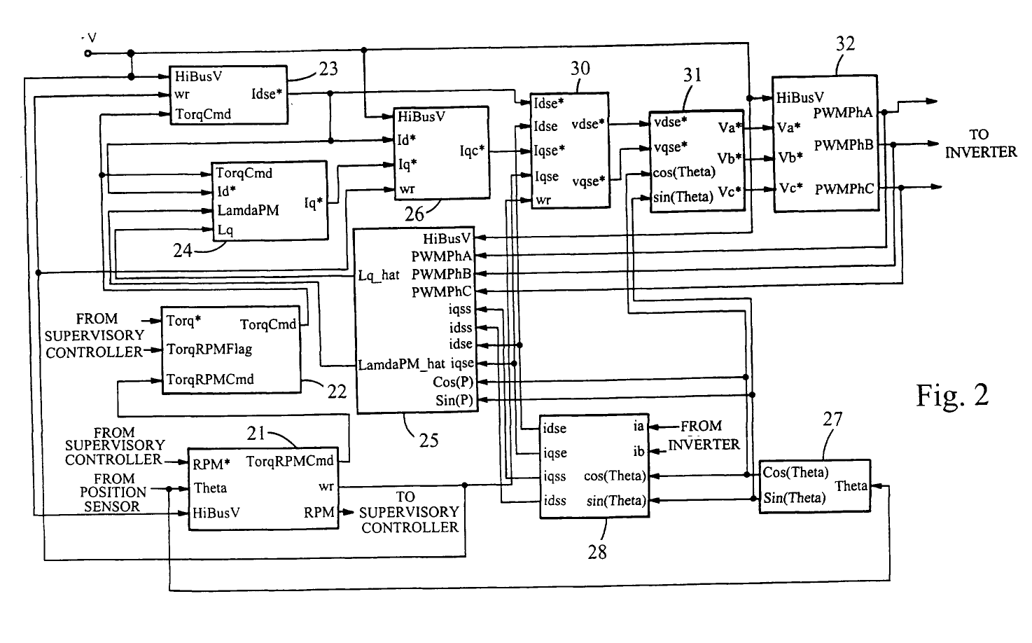

FIG. 2 shows controller 15 in greater detail. A speed regulator 21 receives motor position signal Theta from the position sensor or position estimator, a speed command RPM* from the supervisory controller, and the inverter voltage level HiBusV. It calculates and outputs the mechanical speed of the motor in revolution per minute RPM, electrical speed in radians per second, ωᵣ, and a torque command TorqRPMCmd required to achieve the speed command RPM*. Speed command RPM* may be given by conventional methods, such as the position of a vehicle operator's foot on an accelerator, or may be the result of a set speed on a cruise control system, or determined by the supervisory controller during gearshifts, for example. Motor position Theta is preferably measured by a motor position sensor located on the PM motor, and most preferably located on the rotor shaft of the PM motor. Speed regulator 21 preferably includes a proportional-integral-derivative (PID) controller, wherein the integrator is designed with anti-windup mechanisms to reduce the speed error, as is known in the art. Preferably, the anti-windup mechanisms prevent the integrator from winding up after any saturation of the PID controller.

A torque command to achieve commanded speed (TorqRPMCmd) and a normal torque command Torq* are provided as inputs to a mode selector 22. The supervisory controller (not shown) determines whether the drive system is to run in a speed control mode or a torque control mode and generates a corresponding mode flag TorqRPMFlag. The TorqRPMFlag flag may comprise a digital signal from the vehicle supervisory controller which selects the control mode as described. Speed control mode may preferably be used during gear shifts or engine cranking in case of HEV, whereas torque control mode is preferably used for normal driving and for charging the battery. Mode selector 22 selects either Torq* or TorqRPMCmd to output as a torque command TorqCmd which is coupled to a flux current strategizer 23 and a current decoupler 24.

Flux current strategizer 23 determines a magnetizing (d-axis) current command I_{dse}*. Flux current strategizer 23 receives for its inputs the motor electrical speed ωᵣ, the torque command TorqCmd, and the inverter or battery voltage HiBusV. Preferably, strategizer 23 employs a conventional “maximum torque per ampere” strategy to calculate a value for I_{dse}* which is valid for the entire operating speed range including constant power operation.

Current decoupler 24 calculates the required q-axis current, I_{q}*, for the motor to deliver the required torque command via the relationship between torque and quadrature current I_{q} as known in the art. Current decoupler 24 receives as inputs the d-axis current command I_{dse}*, the torque command TorqCmd, and the values of LamdaPM_hat and Lq_hat received from an open-loop parameter observer 25. This calculated q-axis current command, I_{q}*, is clamped by a limiter 26. The maximum current and voltage capabilities of the power electronics inverter determine the range in which I_{q}* will be clamped by limiter 26. Typically, upper and lower limits are established from modeling and measurements of the physical system. The clamped value I_{qc}* provides the q-axis current command I_{qse}*.

Motor position Theta from sensor 13 is input to a position converter 27 which computes the sine and cosine values of the rotor electrical position, i.e., sin(Theta) and cos(Theta). The sine and cosine values are used in a vector rotation translator 28 to transform motor currents (e.g., measured current values for iₐ and i_{b} from inverter 14) from stationary reference coordinates to synchronous reference coordinates. Preferably, the vector rotation translator uses a Park transformation algorithm, as is known in the art. Thus, vector rotation translator 28 calculates d-axis and q-axis currents in synchronous reference coordinates, I_{dse} and I_{qse} from the motor phase currents in stationary reference coordinates (iₐ and i_{b}) by using appropriate sine and cosine values of the rotor electrical position Theta. As is known in the art, the vector representation in synchronous reference coordinates is a mathematical construct which decouples the effect of the motor phase currents according to their contributions to the magnetic flux and the torque. This representation of the current command vector yields quick and efficient control of the motor. After calculating target control values in vector form, they can be translated back to stationary coordinates for driving the PM synchronous motor.

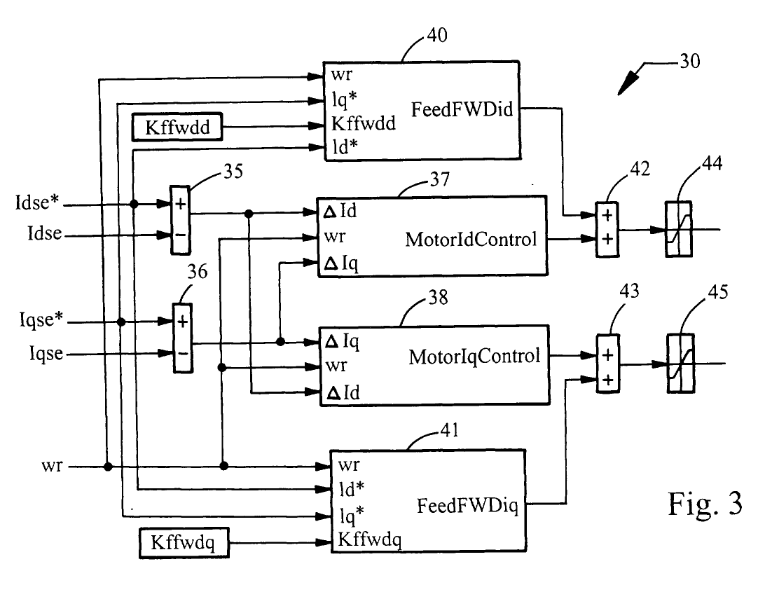

A synchronous current regulator 30 calculates the voltages needed to regulate the d-axis and q-axis current commands, I_{dse}* and I_{qse}*, using the improvements of the present invention as will be described below in connection with FIGS. 3-5.

Continuing with FIG. 2, a second vector rotation translator 31 translates the resulting voltage commands, V_{dse}* and V_{qse}*, in synchronous reference coordinates back to stationary reference coordinates, Vₐ*, V_{b}*, and V_{c}*, for the three phases of the motor. Vector rotation translator 31 is preferably comprised of an inverse Park transformation. Voltage commands Vₐ*, V_{b}*, and V_{c}* represent the actual voltages to be applied to the motor via the power electronics inverter to regulate motor current, and thereby control the torque generated. Preferably, each regulated current waveform is sinusoidal, or AC. A PWM signal generator 32 calculates the necessary pulse-width modulated control signals. Preferably, PWM signal generator 32 uses a space vector modulation technique to synthesize sinusoidal voltage waveforms for minimizing voltage harmonics and improved use of effective inverter voltage, as is known in the art. The PWM signals for the individual motor phases (PWMPhA, PWMPhB, and PWMPhC) are sent to the gate drive circuitry to control the turn-on and turn-off of inverter switches.

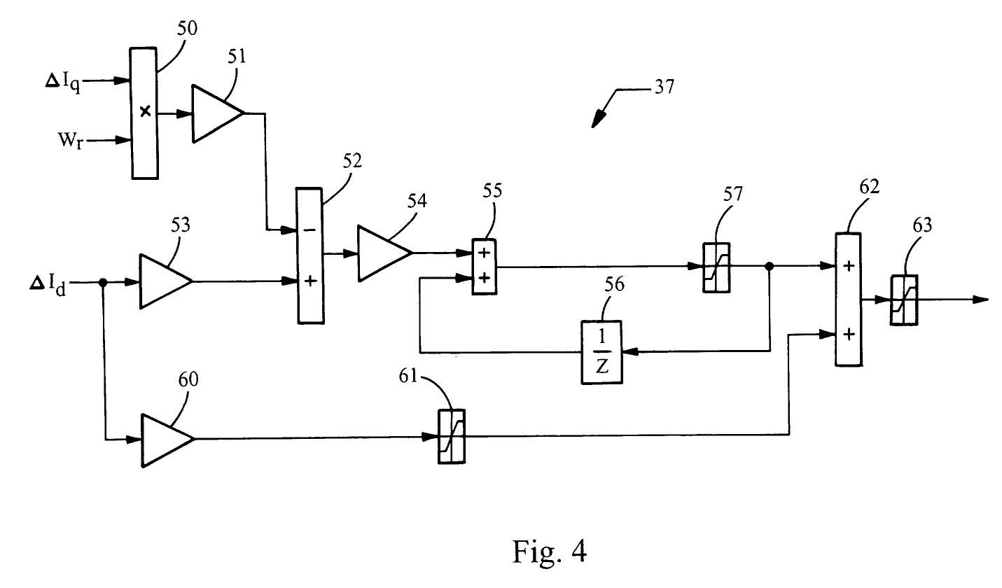

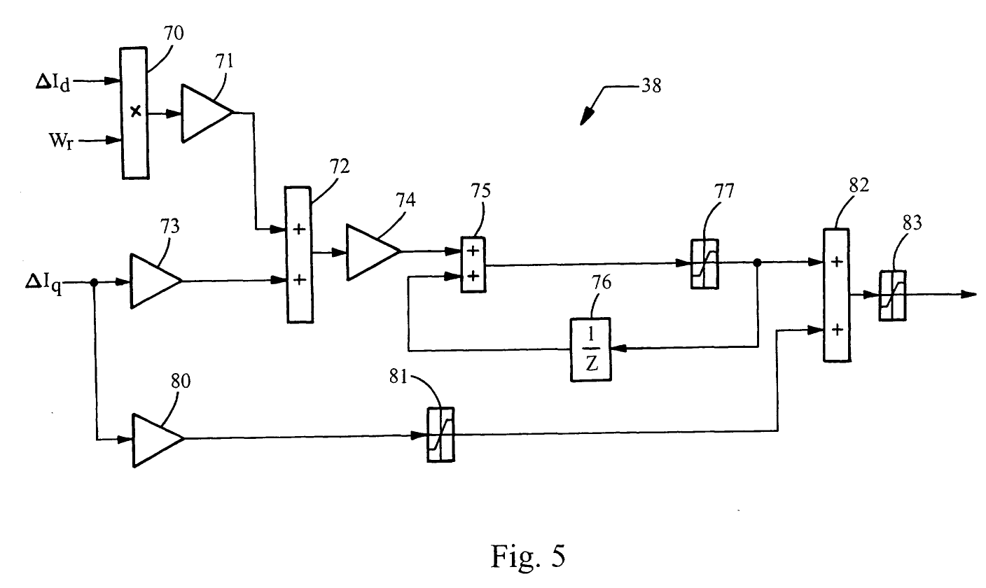

FIG. 3 illustrates a preferred embodiment of the weighted higher-order PI regulator of the present invention for controlling motor phase currents in synchronous coordinates to improve the dynamics of the machine at high operating speeds by showing current regulator 30 in greater detail. Summers 35 and 35 calculate the d-axis and q-axis current regulation errors, ΔI_{d} and ΔI_{q}, respectively, which are input to weighted higher-order PI regulators 37 and 38 that regulate the values Of I_{dse} and I_{qse} respectively. Anti-windup mechanisms are preferably provided in regulators 37 and 38. Further details of PI regulators 37 and 38 will be provided below with reference to FIGS. 4 and 5.

To reduce signal noise transmission through the control system and to improve the dynamics, feed forward compensators 40 and 41 are preferably used to feed forward compensating voltages as known in the art. The use of voltage feed forward compensations allow smaller PI regulator gains, and thereby reduces noise transmission. The required synchronous reference frame voltages needed to regulate d-axis and q-axis current commands are obtained by adding the outputs of PI regulators 37 and 38 and feed-forward voltage signals from compensators 40 and 41 in summers 42 and 43, respectively. After applying appropriate voltage limits in saturation limiters 44 and 45, respectively, the voltage commands in the synchronous reference coordinates, V_{dse}* and V_{qse}*, are determined.

Referring now to FIGS. 4 and 5, preferred embodiments of weighted higher-order PI regulators 37 and 38 for regulating currents I_{dse} and I_{qse}, respectively, are shown. The outputs of weighted higher-order PI regulators 37 and 38, respectively, may be expressed in digital forms as follows:

V_{dse}*=K_{pId}•ΔI_{d}+(K_{iId}−K_{wIq}•ωᵣ•ΔI_{q})•Tₛ/(1−z⁻¹)

V_{qse}*=K_{pIq}•ΔI_{q}+(K_{iIq}+K_{wId}•ωᵣ•ΔI_{d})•Tₛ/(1−z⁻¹)

where K_{pId} and K_{pIq} are proportional gains for regulators 37 and 38, respectively, K_{iId} and K_{iIq} are integral gains for regulators 37 and 38, respectively, K_{wIq} and K_{wId} are weighting factors for regulators 37 and 38, respectively, Tₛ is the sampling time, and z⁻¹ is a unit delay (for performing integration). Regulators 37 and 38 primarily differ from prior art regulators in the addition of weighted higher-order terms (K_{wIq}•ωᵣ•ΔI_{q}) and (K_{wId}•ωᵣ•ΔI_{d}).

FIG. 4 shows PI regulator 37 in greater detail. A multiplier 50 calculates the product of current error ΔI_{q} and machine speed ωᵣ. This product is then multiplied by weighting factor K_{wIq} by means of a gain block 51 with a gain equal to K_{wIq} to generate the weighted higher order term which is then input to a subtracting input of a summer 52. Current error ΔI_{d} is multiplied by the integral gain K_{iId} in gain multiplier 53, and the output is provided to the additive input of summer 52. The output of summer 52 is multiplied by the sampling time Tₛ in a gain multiplier 54 to provide the contribution of the integral term for the present time sample. An error integration action is performed at a summer 55 that accumulates the previous integral value from a unit delay 56. The output of summer 55 is clamped by a limiter 57 to prevent windup of the digital integrator. The contribution from the proportional term is calculated in a multiplier 60 (which has a gain equal to K_{pId}) and is clamped in a limiter 61. The contributions from the proportional term (i.e., the output of limiter 61) and the integral term (i.e., the output of limiter 57) are added together in a summer 62 to determine the voltage needed to regulate the motor current. The output of summer 62 is further clamped in a limiter 63 to provide the output of PI regulator 37.

FIG. 5 shows PI regulator 38 in greater detail. A multiplier 70 calculates the product of current error ΔI_{d} and machine speed ωᵣ. This product is then multiplied by weighting factor K_{wId} by means of a gain block 71 with a gain equal to K_{wId} to generate the weighted higher order term which is then input to an adding input of a summer 72. Current error ΔI_{q} is multiplied by the integral gain K_{iIq} in gain multiplier 73, and the output is provided to another adding input of summer 72. The output of summer 72 is multiplied by the sampling time Tₛ in a gain multiplier 74 to provide the contribution of the integral term for the present time sample. An error integration action is performed at a summer 75 that accumulates the previous integral value from a unit delay 76. The output of summer 75 is clamped by a limiter 77 to prevent windup of the digital integrator. The contribution from the proportional term is calculated in a multiplier 80 (which has a gain equal to K_{pIq}) and is clamped in a limiter 81. The contributions from the proportional term (i.e., the output of limiter 81) and the integral term (i.e., the output of limiter 77) are added together in a summer 82 to determine the voltage needed to regulate the motor current. The output of summer 82 is further clamped in a limiter 83 to provide the output of PI regulator 38.

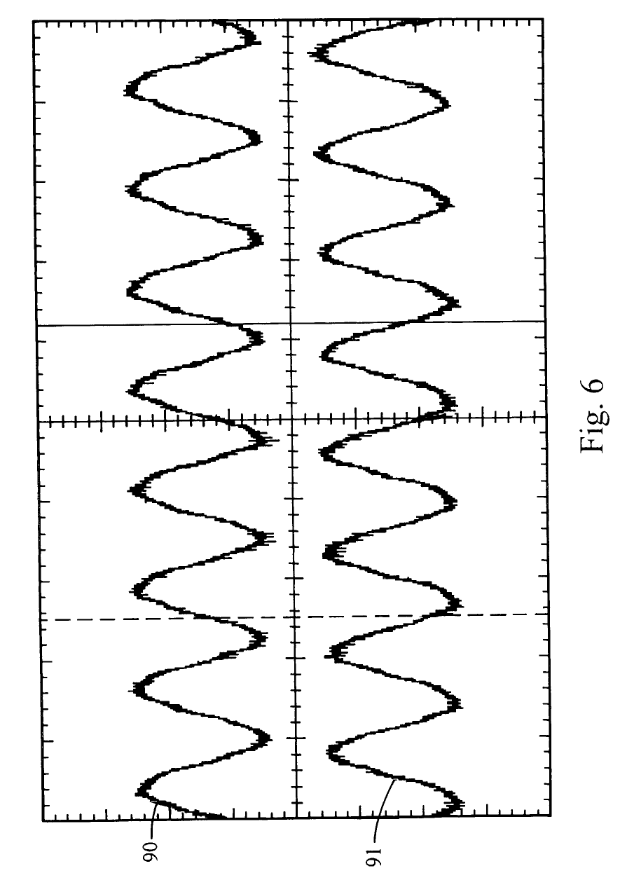

FIG. 6 shows measured phase current waveforms 90 and 91 for motor phases A and B, respectively, for a PM synchronous motor running at a mechanical speed of 4000 RPM with an output torque of 32 Nm. The resulting phase currents are stable and well-controlled despite the operation at high speed and low torque.

The invention provides a major performance improvement for vector-controlled PM synchronous machines and enables the practical use of such drive systems in automotive ISA, HEV, and EV applications. Although a PM synchronous machine for automotive applications has been shown, it will be apparent to those skilled in the art that the invention can be applied to vector controls of AC electric machines in general and can provide great benefits when used in general industrial applications where the AC machine drives are used.

What is claimed is:

1. A method of controlling a permanent magnet synchronous machine comprising the steps of:
determining a d-axis current command I_{dse}* and a q-axis current command I_{qse}* to achieve a desired response of said machine;
sensing an actual d-axis current I_{dse} and an actual q-axis current I_{qse};
sensing an angular velocity ωᵣ of said machine;
determining a d-axis voltage command V_{dse}* using a first proportional-integral regulator responsive to a d-axis current error ΔI_{d}, a q-axis current error ΔI_{q}, and said angular velocity ωᵣ, wherein said d-axis current error comprises a difference between said d-axis current command I_{dse}* and said actual d-axis current I_{dse}, wherein said q-axis current error comprises a difference between said q-axis current command I_{qse}* and said actual q-axis current I_{qse}, and wherein said first proportional-integral regulator includes a first weighted higher order term comprising a product of a first weighting factor, said angular velocity ωᵣ, and said q-axis current error ΔI_{q}; and
determining a q-axis voltage command V_{qse}* using a second proportional-integral regulator responsive to said d-axis current error ΔI_{d}, said q-axis current error ΔI_{q}, and said angular velocity ωᵣ, wherein said second proportional-integral regulator includes a second weighted higher order term comprising a product of a second weighting factor, said angular velocity ωᵣ, and said d-axis current error ΔI_{d}.

2. The method of claim 1 further comprising the steps of:
summing a d-axis feed-forward voltage compensation with an output of said first proportional-integral regulator to determine said d-axis voltage command V_{dse}*; and
summing a q-axis feed-forward voltage compensation with an output of said second proportional-integral regulator to determine said q-axis voltage command V_{qse}*.

3. The method of claim 1 further comprising the steps of:
translating said d-axis voltage command V_{dse}* and said q-axis voltage command V_{qse}* into stationary reference commands Vₐ*, V_{b}*, and V_{c}*; and
pulse-width modulating voltages supplied to respective phase windings of said machine in response to said stationary reference commands Vₐ*, V_{b}*, and V_{c}*.

4. The method of claim 1 wherein said first weighted higher order term is determined according to a formula:
K_{wIq}•ωᵣ•ΔI_{q}
where K_{wIq} is said first weighting factor.

5. The method of claim 1 wherein said second weighted higher order term is determined according to a formula:
K_{wId}•ωᵣ•ΔI_{d}
where K_{wId} is said second weighting factor.

6. The method of claim 1 wherein said first proportional-integral regulator is characterized by a formula:
V_{dse}*=K_{pId}•ΔI_{d}+(K_{iId}−K_{wIq}•ωᵣΔI_{q})•Tₛ/(1−z⁻¹)
where K_{pId} is a proportional gain, K_{iId} is an integral gain, K_{wIq} is said first weighting factor, and Tₛ is a sampling time.

7. The method of claim 6 wherein said second proportional-integral regulator is characterized by a formula:
V_{qse}*=K_{pIq}•ΔI_{q}+(K_{iIq}+K_{wId}•ωᵣ•I_{d})•Tₛ/(1−z⁻¹)
where K_{pIq} is a proportional gain, K_{iIq} is an integral gain, and K_{wId} is said second weighting factor.

8. A motor controller for a permanent magnet synchronous machine, comprising:
a speed sensor for determining an angular velocity ωᵣ of said machine;
a current sensor for sensing an actual d-axis current I_{dse} and an actual q-axis current I_{qse};
a torque controller for providing a torque command;
a d-axis current calculator for determining a d-axis current command I_{dse}* in response to said torque command;
a q-axis current calculator for determining a q-axis current command I_{qse}* in response to said torque command;
a current regulator for determining a d-axis voltage command V_{dse}* and a q-axis voltage command V_{qse}* corresponding to said d-axis current command I_{dse}* and said q-axis current command I_{qse}*, respectively;
a vector translator for translating said d-axis voltage command V_{dse}* and said q-axis voltage command V_{qse}* into stationary reference commands Vₐ*, V_{b}*, and V_{c}*;
a PWM controller for generating pulse-width modulation control signals corresponding to said stationary reference commands Vₐ*, V_{b}*, and V_{c}*; and
an inverter for applying respective voltages to phase windings of said machine in response to said pulse-width modulation control signals;
wherein said current regulator comprises:
a first proportional-integral regulator responsive to a d-axis current error ΔI_{d}, a q-axis current error ΔI_{q}, and said angular velocity ωᵣ, wherein said d-axis current error comprises a difference between said d-axis current command I_{dse}* and said actual d-axis current I_{dse}, wherein said q-axis current error comprises a difference between said q-axis current command I_{qse}* and said actual q-axis current I_{qse}, and wherein said first proportional-integral regulator includes a first weighted higher order term comprising a product of a first weighting factor, said angular velocity ωᵣ, and said q-axis current error ΔI_{q}; and
a second proportional-integral regulator responsive to said d-axis current error ΔI_{d}, said q-axis current error ΔI_{q}, and said angular velocity ωᵣ, wherein said second proportional-integral regulator includes a second weighted higher order term comprising a product of a second weighting factor, said angular velocity ωᵣ, and said d-axis current error ΔI_{d}.

9. The motor controller of claim 8 wherein said current regulator further comprises:
a d-axis feed-forward voltage compensator generating a d-axis compensation signal for summing with an output of said first proportional-integral regulator to determine said d-axis voltage command V_{dse}*; and
a q-axis feed-forward voltage compensator generating a q-axis compensation signal for summing with an output of said second proportional-integral regulator to determine said q-axis voltage command V_{qse}*.

10. The motor controller of claim 8 wherein said first proportional-integral regulator is characterized by a formula:
V_{dse}*=K_{pId}•ΔI_{d}+(K_{iId}−K_{wIq}•ωᵣ•ΔI_{q})•Tₛ/(1−z⁻¹)
where K_{pId} is a proportional gain, K_{iId} is an integral gain, K_{wIq} is said first weighting factor, and Tₛ is a sampling time.

11. The motor controller of claim 10 wherein said second proportional-integral regulator is characterized by a formula:
V_{qse}*=K_{pIq}•ΔI_{q}+(K_{iIq}+K_{wId}•ωᵣ•ΔI_{d})•Tₛ/(1−z⁻¹)
where K_{pIq} is a proportional gain, K_{iIq} is an integral gain, and K_{wId} is said second weighting factor.
